(19) United States
(12) Patent Application Publication
(10) Pub. No.: US 2010/0270370 A1
(43) Pub. Date: Oct. 28, 2010

(54) METHOD AND SYSTEM FOR CONTROLLING SMARTCARDS

(75) Inventor: Randle Cowcher, Edinburgh (GB)

Correspondence Address: LUCAS & MERCANTI, LLP, 475 PARK AVENUE SOUTH, 15TH FLOOR, NEW YORK, NY, 10016, US

(73) Assignee: The Royal Bank of Scotland plc, Edinburgh (GB)

(21) Appl. No.: 12/646,193

(22) Filed: Dec. 23, 2009

Related U.S. Application Data
(63) Continuation of application No. PCT/GB2008/002195, filed on Jun. 26, 2008.

(30) Foreign Application Priority Data
Jun. 26, 2007 (GB) GB 0712406.8

(51) Int. Cl. G06K 17/00; G06Q 40/00; G06F 7/04

(52) U.S. Cl. 235/379; 235/380; 340/5.1

(57) ABSTRACT

This invention relates to a method and system for controlling smartcards which are capable of audiovisual output. Data stored remotely from the smartcard can be monitored for indication of a predetermined criterion and/or change in status of an account associated with the smartcard, for example indication of a certain level of funds in a smartcard user's bank account. A control signal can then be communicated to the smartcard for controlling the update of audiovisual output from the smartcard. The control signal can thus be communicated to the smartcard in response to a trigger generated externally of the smartcard. Data relating to audiovisual output of the smartcard may be stored on the smartcard itself, in which case the control signal may indicate to the smartcard to update its audiovisual output according to audiovisual data already present on the smartcard.

### CROSS-REFERENCED TO RELATED APPLICATIONS

This is a continuation of International Application PCT/GB2008/002195 filed Jun. 26, 2008, which claims priority under 35 USC 119 of United Kingdom Patent Application No. GB 0712406.8 filed Jun. 26, 2007, the entire disclosure of each of which is incorporated herein by reference.

### FIELD OF THE INVENTION

The present invention relates to a method and system for controlling smartcards. In particular, the invention relates to the control of smartcards which are capable of audiovisual output.

### BACKGROUND OF THE INVENTION

Smartcards are active devices which have some form of data processing capability in the form of a microchip or microprocessor. This data processing capability may be used in relation to a wide variety of applications for credit, debit or other identity, entitlement or benefits cards. Such smartcards tend to have a fairly standard size and shape, but only a relatively small part of the card is actually used for its core function and applications. This part is typically the magnetic or optical ‘stripe’ or other bar codes and printed or embossed characters and numbers. Some smartcards which follow the ISO 7816 standard, sometimes known as ‘EMV’ or ‘Chip and PIN’ cards, also include a contact patch used principally to connect to a microchip embedded in the card. Where the card is issued under a defined scheme (such as MasterCard™ or Visa™), some further identification and/or a security device may be incorporated, for example a hologram.

There is a growing move to incorporate more functions and applications on the microchip within the card. It is now possible to set out and display other information across both sides of the card and to be able to display some data about these applications either on the card itself, by using an incorporated and powered display. Such visual output can currently be provided using 8-segment displays and can be applied in any size or number that can fit on the smartcard, for example 8 sets of 8-segment displays, and even 24 sets or more. Such displays require an additional microprocessor chip to which suitable power can be applied either via connections on a contact patch, or inductively to change the status of the display. The use of current persistent displays is such that the status can remain unchanged and readable without the continuous application of power for long periods of time, which may exceed one year or more. Such displays may be monochromatic, showing a change from clear to grey/black in the required segments, but more recently may also involve multi-coloured electronic ink technology.

It is now also possible to incorporate one or more audio transmitters in a smartcard, for example using flat panel loudspeaker technology such as that produced by NXT™. Such a smartcard is thus capable of providing audio output.

It is thus possible for smartcards to include audio output and/or visual output functionality, the output of one or the other or both being defined herein as audiovisual output.

U.S. Pat. No. 6,745,944 describes a system and method for identifying applications loaded in a smart card. The smart card has a display and is capable of storing application programs and displaying symbols or logos of the stored application programs to allow a user to view which applications are currently available in the smart card. Display changes on the smartcard only occur in relation to the application running on the smartcard.

United States patent application no. US 2006/0065741 describes a multi-application smartcard and method for updating a dynamic display portion thereof. In one embodiment, the smartcard includes a dynamic display portion incorporating electronic ink, in which the dynamic display portion changes from a first display to a second display in response to an application use of the smartcard. Such dynamic display changes are limited to be responsive to the application running on the smartcard.

### SUMMARY OF THE INVENTION

In accordance with a first aspect of the present invention, there is provided a method of controlling a smartcard, said smartcard being associated with an account and being capable of audiovisual output, said method comprising the steps of:

monitoring data stored remotely from said smart card, said stored data being associated with said audiovisual output;

in response to said monitored data indicating a change in a status of said account, communicating a control signal to said smart card, said control signal being for controlling said smart card to update an audiovisual output thereof.

Hence by use of the present invention, it is possible to update the audiovisual output of a smartcard having an associated account by communicating a control signal to the smartcard. Data stored remotely from the smartcard can be monitored for indication of a change in status of the associated account, for example indication of a certain level of funds in a smartcard user's bank account or an information message to be communicated to the smartcard user. A control signal can then be communicated to the smartcard for controlling the update of audiovisual output from the smartcard. The control signal can thus be communicated to the smartcard in response to a trigger generated externally of the smartcard. Data relating to audiovisual output of the smartcard may be stored on the smartcard itself, in which case the control signal may indicate to the smartcard to update its audiovisual output according to audiovisual data already present on the smartcard.

The method may further comprise communicating audiovisual output data to said smartcard. Hence, audiovisual output data may be communicated to the smartcard and the smartcard is able to update its audiovisual output using the audiovisual output data which has been communicated to it.

The audiovisual output data may be communicated to said smartcard with said control signal. Hence the control signal can perform the combined function of indicating to the smartcard to update its audiovisual output and also to supply to the smartcard new audiovisual output data relating to the update.

The communication to said smart card may occur wirelessly in response to said smart card coming within communication range of an updating terminal. The smartcard may come within range of an updating terminal if a person carrying the card comes within a sufficiently close proximity of an updating terminal, for example walking into a building such as a bank where an updating terminal may be situated. The control signal may thus be communicated wirelessly, i.e. contactlessly, for example according to the ISO 14443 format, and may provide power to the smartcard to allow wireless reception of the signal. Alternatively, the smartcard may comprise its own power source which enables it to receive the control signal over a wireless connection.

Updating terminals may for example comprise Automated Teller Machine (ATM) terminals located in the walls of buildings, inductive loops located at the entrance of buildings or other convenient sites, Streamline™ or other point of sale (POS) terminals, transport barriers and other card or token readers. An updating terminal may comprise a defined gate located at the entrance to a shop where an inductive coil is used to sense and communicate to the smartcards in order to update their audiovisual output.

The updating terminals may also comprise smartcard reader/writers attached to home or business personal computers (PCs), fixed or mobile telephones, personal digital assistants (PDAs) and such like. Such updating terminals could be used to create new audiovisual output for uploading to the smartcard or for editing or deletion of the current audiovisual output.

In some embodiments, the range comprises a radio frequency range, for example a radio frequency Identification Data (RFID) range. Hence, the communication can be initiated when the smartcard comes into radio frequency reception range of an updating terminal.

In some embodiments the communication may occur via one or more electrical contacts in response to said smartcard being inserted into an updating terminal. Hence, the communication can occur when the smartcard is physically inserted into a slot of an updating terminal by a user. The control signal can thus be communicated to the smartcard when one or more electrical contacts on the smartcard come into contact with corresponding electrical contacts in the updating terminal.

The audiovisual output data may relate to visual data to be output from said smartcard. Hence, the smartcard may update its visual output, for example static or moving text or images on a display. The updated visual output from the smart card may thus change the appearance of the smartcard as perceived by a user. The change in appearance may affect substantially the whole or a significant part of one or more surfaces of said smartcard.

The audiovisual data may be capable of being output from said smartcard using electric ink. Such electric (or electronic ink) technology is currently being developed by companies such as Xerox™ and E Ink™.

The audiovisual output data may relate to audio data to be output from said smartcard. Hence, the smartcard may update its audio output, for example comprising a sound emitted by one or more audio transmitters located on or embedded in the smartcard.

The stored data may comprise data associated with one or more of a bank account, a store account, and a date. Hence, the monitored data may relate to a bank account held by a smartcard user, for example the balance a smartcard user has remaining. The monitored data may relate to a store account a smartcard user holds, for example the number of points the user has on their account or purse that they have accumulated through use of the account. The monitored data could also relate to a date associated with or relevant to a smartcard user, such as a birthday, anniversary or a more general date such as a public or national holiday, or local discount (e.g. ‘blue saver’) days.

In some embodiments, the audiovisual output may be indicative of the status of said bank account and/or said store account. For example the status could be a silver or gold status for users with a relatively high bank balance or high number of points. Hence, when a smartcard user reaches a predetermined level of saving, the audiovisual output on their smart card could be changed to indicate this fact, for example changing from a colour associated with a standard account to e.g. a platinum colour associated with a more exclusive account.

The audiovisual output may be indicative of the status of a further account in addition to said bank account and/or said store account, said further account being operable in association with transactions carried out in relation to said bank account and/or said store account. Hence the audiovisual output may also be updated according to the status or balance of a further account in addition to a bank and/or store account. The further account may be associated with a bank account and/or store account, for example a Keep the Change™ account whose balance may change when transactions occur in the bank and/or store account.

Additionally, or alternatively, the status may comprise a lost or stolen status of said smartcard. Hence, the audiovisual output may indicate that the smartcard has been reported or deemed lost or stolen, for example to assist in fraud prevention.

The audiovisual output may be indicative of the temporal proximity of a date. Hence, the audiovisual output of the smartcard can help to remind a user of a date which is important to them, for example a wedding anniversary or important meeting or such like.

The method may further comprise the step of updating said stored data, for example in response to a change in one or more of a bank account, a store account, and a date. Hence, the stored data may change when money is paid into a smartcard user's bank account or the number of points increase on their store account. The stored data may also change when a smartcard user adds or edits a date in the remotely stored data, for example the birthday of a new associate. This could be implemented by a profile in the remotely stored data associated with and accessible by a smartcard user.

The stored data may be updated remotely via a communications network. Hence, a smartcard user may update the stored data remotely, such as a preferences profile, over a communications network such as the Internet or a mobile telecommunications network.

The change in account status may comprise a threshold being reached in said stored data. The threshold may for example be a certain amount of money in a bank account associated with the smartcard and/or user, for example an amount which is sufficient to allow the smartcard user access to a different type or level of bank account. The threshold may relate to a certain amount of user spending or number of points on a store account, for example sufficient loyalty points to enable the smartcard user to redeem the points in exchange for a certain item or holiday or other such reward. The threshold may relate to a date and may change in a temporal fashion, for example when there are a certain number of days to go before an event or other date.

The control signal may be encrypted. Hence, unauthorised control signals may be detected and processed differently to authorised control signals.

The control signal may comprise part of a secure handshake authentication procedure. Hence, communication between updating terminals and smartcards may involve exchange of authentication messages before control of audiovisual output is authorised to proceed.

The method may comprise the step of, prior to said communication of said control signal, generating trigger data in response to said monitored data indicating a change in a status of said account, said trigger data being generated for the purpose of notifying one or more updating terminals that audiovisual output of a smartcard is to be carried out.

The trigger data may be stored remotely from said smartcard.

The method may comprise the step of notifying one or more updating terminals that audiovisual output of a smartcard is to be carried out by transmitting said trigger data to said one or more updating terminals.

The notification may be carried out in response to an enquiry from an updating terminal when a smartcard comes within its communication range.

Hence, when a change in account status has been detected in stored data associated with a smartcard, one or more smartcard updating terminals may be notified that the audiovisual output of the smartcard should be updated.

The notification may take place as soon as the trigger data is generated and may involve transmitting the trigger data to one or more updating terminals. If one of these notified updating terminals detects that the smartcard has come within its range, then it can send a control signal to the smartcard to control the audiovisual output update.

Alternatively, once generated, trigger data may be stored remotely from said smartcard, for example in a database such as that used to store data associated with audiovisual output. When a smartcard comes within range of an updating terminal, the updating terminal may initiate an enquiry as to whether the audiovisual output of the smartcard should be updated. In response to such an enquiry, the stored trigger data can be accessed and if trigger data for the smartcard is present, the trigger data can be transmitted to the enquiring updating terminal which can then control update of the audiovisual output accordingly.

In accordance with second and third aspects of the invention, there is provided apparatus and computer software adapted to perform the method of the first aspect of the invention.

In accordance with a fourth aspect of the present invention, there is provided a system for controlling a smart card, said smartcard being associated with an account and being capable of audiovisual output, said system comprising:

a database adapted to store data remotely from said smart card;

a monitoring means adapted to monitor data stored in said database;

a communication means adapted to communicate a control signal to said smartcard in response to said monitored data indicating a change in a status of said account, said control signal being for controlling said smartcard to update an audiovisual output thereof.

Hence, apparatus can be provided which is adapted to control a smartcard, in particular to update its audiovisual output.

The smartcard may comprise an audiovisual output means adapted to output audiovisual data. Such audiovisual output means may comprise one or more graphics display portions or one or more audio transmitters.

The graphics display portions may comprise liquid crystal display (LCD) technology. LCDs state changes may be driven by an array of drivers located towards or at the outer edges of the smartcard, or by using a thin film matrix across the whole surface of the card to drive a matrix array of electro-optical ‘ink’ segments. The smartcard LCDs could be loaded with suitable crystal elements or liquids that have the ability to show at least two and preferably more colour sets or states. A matrix of Organic Light Emitting Diodes (OLEDs) could also function in a similar manner to a surface layer display across the surface of the smartcard.

An example set of smartcard surface display colours could be of blue, silver, gold, and black. The smartcard could be issued in a base state of say blue, but on reaching a defined usage point, such as a set value, duration of ownership, or other defined reasons, a change of status is warranted. At such a point, on logging on at an ATM, or use at a fully connected and suitably equipped POS terminal, the card could receive a secure control signal allowing the audiovisual output display status of the card to change, for example to silver. The power for such an audiovisual output change may come from the updating terminal, either via contacts or wirelessly. Alternatively or additionally, the power for audiovisual updates may come from a power source located on the smartcard, for example the smartcard may comprise a small battery or capacitor system that may require replacement when exhausted or may allow charging by an updating terminal. The power source may be able to sustain itself by self-charging such as via a kinetic or photo-voltaic module embedded in the card. Once such a change in state is made, it may be persistent in that it remains in that state until another change of state signal is applied.

The graphics display(s) or screen(s) may be used to display messages across the card, such as ‘Happy Birthday’, ‘Special Offer’, ‘Call the bank’, etc. until the messages are deleted or cancelled during use at another updating terminal or such location.

The audiovisual output means may alternatively or additionally comprise one or more audio transmitters embedded in or located on one or more surfaces of the smartcard. The audio transmitters may comprise flat panel loudspeaker technology such as that produced by NXT™. The audio transmitters may be adapted, or tuned, to act as audio loudspeakers when inserted in or when in close proximity to a suitable terminal. The same or an expanded range of messages that are displayed visually on the smartcard may then be ‘broadcast’ to the owner—as an ‘audio bar-code’ or in plain language, either instead of or in addition to the visual output. Such audio output could comprise the repetition of data from a smartcard graphics/text display or from updating, for example the amount of a withdrawal transaction, or the amount remaining in a ‘purse’ or loyalty value account such as the remaining value of stored travel rights, ‘club points’ etc.

The smartcard may comprise a receiving means adapted to receive said communicated control signal. Hence, the smartcard is able to receive control signals from updating terminals, for example using one or more antennae or contacts located on or embedded in the smartcard.

The smartcard may comprise an audiovisual update means adapted to update said audiovisual output in response to reception of said communicated control signal. Hence, the smartcard is able to process received control signals and update its audiovisual output accordingly.

In accordance with a fifth aspect of the present invention, there is provided a method of controlling a smartcard, said smartcard being capable of audiovisual output, said method comprising the steps of monitoring data stored remotely from said smart card, said stored data being associated with said audiovisual output, in response to said monitored data indicating a predetermined criterion, communicating a control signal to said smart card, said control signal being for controlling said smart card to update an audiovisual output thereof, said controlling being conducted independently of the operation of one or more applications running on said smartcard.

Thus, in contrast to the prior art, by employing the present invention it is possible to control the audiovisual output of a smartcard independently of one or more applications running on or supported by the smartcard. Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a plan view of one side of a smartcard according to the prior art.

FIG. 2 shows a plan view of one side of a smartcard according to further prior art.

FIG. 3 shows a system architecture view according to an embodiment of the invention.

FIG. 4 shows a system architecture view according to a further embodiment of the invention.

FIG. 5 shows a system flow diagram according to an embodiment of the invention.

FIG. 6 shows a detailed architecture view according to a still further embodiment of the invention.

### DETAILED DESCRIPTION OF THE INVENTION

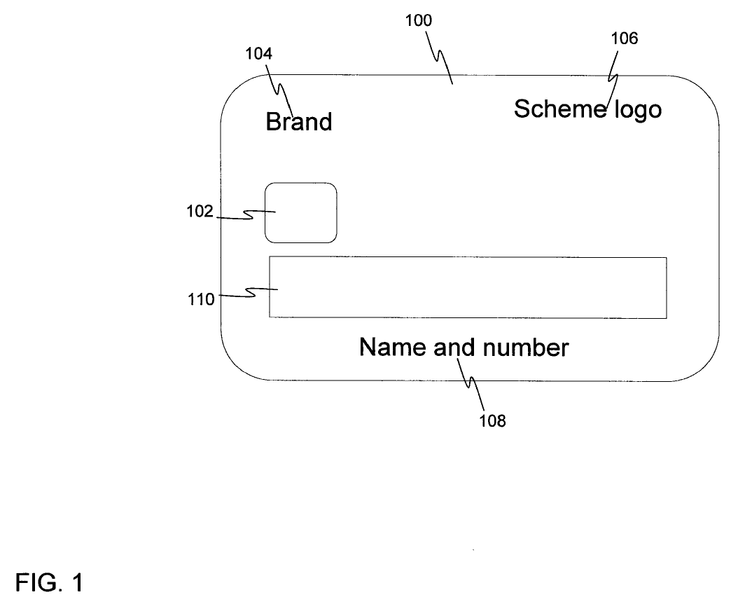

FIG. 1 shows a plan view of one side of a smartcard 100 according to the prior art. Smartcard 100 comprises a microchip with electrical contacts 102, an area 104 for indication of the brand of the smartcard issuer, for example The Royal Bank of Scotland™, an area 106 for indication of a scheme logo, for example Switch™ or Visa™, and an area 108 for indication of the smartcard holder name and associated smartcard number. The layout of the smartcard may vary between different issuers and smartcard types.

Smartcard 100 also comprises a display portion 110 which is capable of audiovisual output. Current technology allows incorporation of a small battery or capacitor system to maintain a powered display using LED or liquid crystal and backlight technologies. However, using ‘electro-magnetic inks or new generation liquid crystal displays (without a backlight), the display portion 110 may not need to have its own power source, but its audiovisual output may be updated under the control of microchip 102. Updating of audiovisual output from the smartcard may occur via electrical connections internal to the smartcard between microchip 102 and display portion 110. Microchip 102 and/or display portion 110 may have their own power source(s), or may power up when the smartcard is within range of or inserted in a suitable updating terminal. The opposing side of smartcard 100 (not shown) may comprise a magnetic or optical stripe and an area for the signature of the smartcard holder and possibly contact details and other relevant party logos.

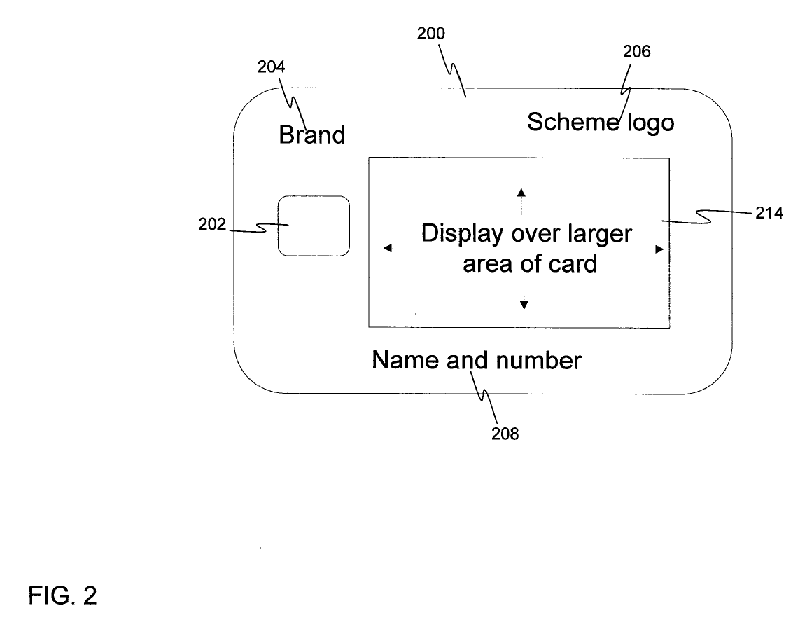

FIG. 2 shows a plan view of one side of a smartcard 200 according to further prior art. Smartcard 200 similarly comprises a microchip with electrical contacts 202, an area 204 for indication of the brand of the smartcard issuer, an area 206 for indication of a scheme logo, and an area for indication of the smartcard holder name and associated smartcard number. Smartcard 200 also comprises a display portion 214 which is capable of audiovisual output. The main difference between smartcard 100 and smartcard 200 is that the latter comprises a display portion which covers a larger proportion of the surface of the smartcard, which can help to make the audiovisual output of the smartcard more prominent. The display portion may also perform the function of any of the brand area 204, logo area 206 and name and number area 208 by including the relevant information in its audiovisual output display. It should be noted that the present invention encompasses the expansion of the display 214 to cover substantially the whole of the display surface area of card 200 where a contactless card is used, or the whole surface excluding the contact patch 202 where a contact process is also required.

The opposing side (not shown) of smartcard 200 may also be comprised substantially of a further display portion, the signature and bar stripe excepted.

LCD or thin film matrix technology could for example be employed to implement such smartcard displays. Embodiments of the invention propose to modify such prior art smartcards such that they contain one or more displays which cover the majority of the smartcard surface, making the audiovisual output of the smartcard more prominent still. This may involve electro-luminescent dyes or magnetic inks in a thin matrix located across the available surface of the smartcard. By changing the polarity or alignment of the molecules of dye or crystals, the colour, picture, pattern or display remain visible as required until a change is implemented. This may involve use of robust thin film technology with a persistent state, i.e. an input is required to change the alignment or state of the display, which does not fade or fall back to a different state when that input is removed. The display process could be controlled via a microprocessor included in the smartcard and could be activated via a contact patch, as with current ‘Chip and PIN’ cards, or via contactless control signals.

To guard against abuse and misuse of the process, changes to the smartcard may only be enabled via the input of a suitably secure master or product code (as with EMV cards), a smartcard user PIN and/or biometric input. Control signals and audiovisual output data passing to and from the smartcard may be encrypted. The process may only proceed if authorisation has been obtained, for example using an authentication handshake procedure between the smartcard and an updating terminal.

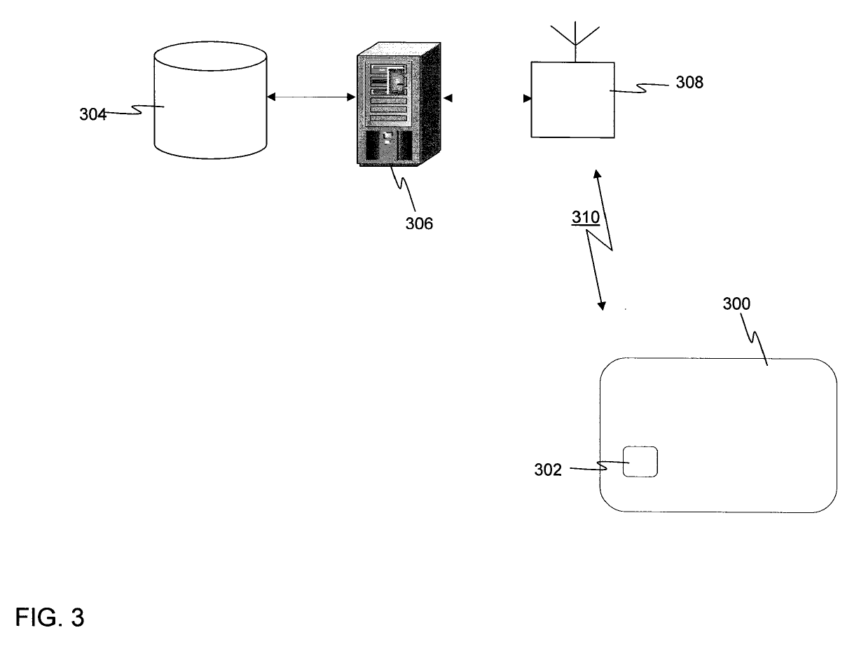

FIG. 3 shows a system architecture view according to an embodiment of the invention. Data associated with smartcard audiovisual output is stored in a database 304. The database is connected to computing equipment 306 with data processing capabilities, such as a server, workstation or PC. Computing equipment 306 is in turn connected to an updating terminal 308. In this embodiment, updating terminal 308 comprises a communication means 308 with data transmission and reception capabilities, such as a RFID transmitter or transceiver. Updating terminal 308 is thus able to communicate with smartcard 300 which contains a microchip 302.

Computing means 306 monitors the data stored in database 304 for indication of one or more predetermined criterion and/or a change in the status of an account associated with the smartcard. If a change in account status and/or a predetermined criterion is detected in the stored data, then control of the audiovisual output of smartcard 300 is desired. This is carried out by communicating a control signal to the smartcard. The function of the control signal is for controlling the smartcard in order that it may update its audiovisual output.

Communication may take the form of transmission of one or more control signals and/or audiovisual output data to smartcard 300 via a wireless or inductive communications link 310. Communication may take place when smartcard 300 comes within radio or inductive range of updating terminal 308.

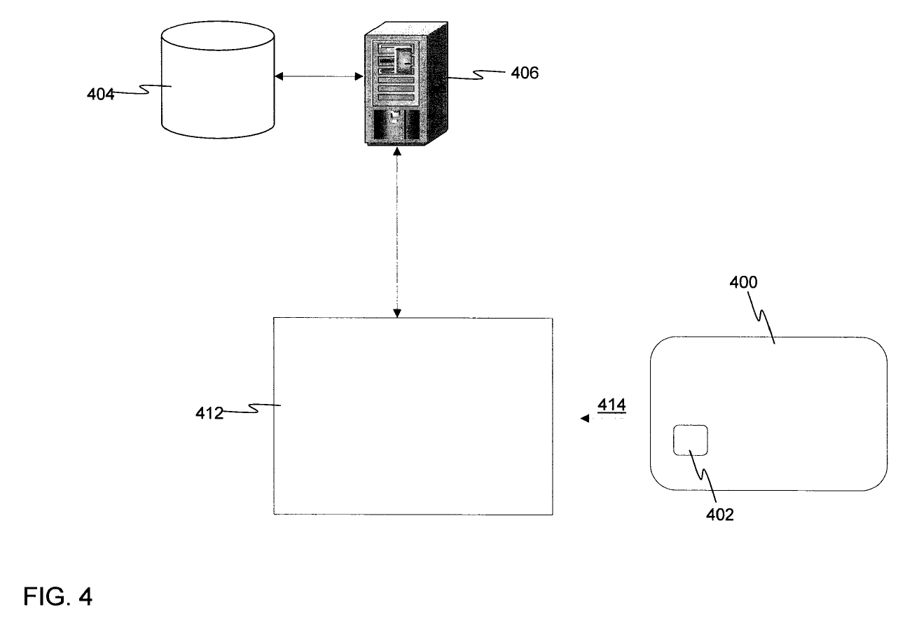

FIG. 4 shows a system architecture view according to a further embodiment of the invention. This embodiment similarly contains a database 404 for storing data associated with smartcard audiovisual output, accessible by computing equipment 406 with data processing capabilities, which is in turn connected to an updating terminal 412. In this embodiment, however, updating terminal 412 is adapted to physically receive smartcard 400, containing microchip 402. When smartcard 400 is inserted 414 into updating terminal 412, updating terminal may communicate with microchip 402 on smartcard 400 via one or more electrical contacts. Similarly, the communication may take the form of transmission of control signals and/or audiovisual output data to smartcard 300 via the one or more electrical contacts.

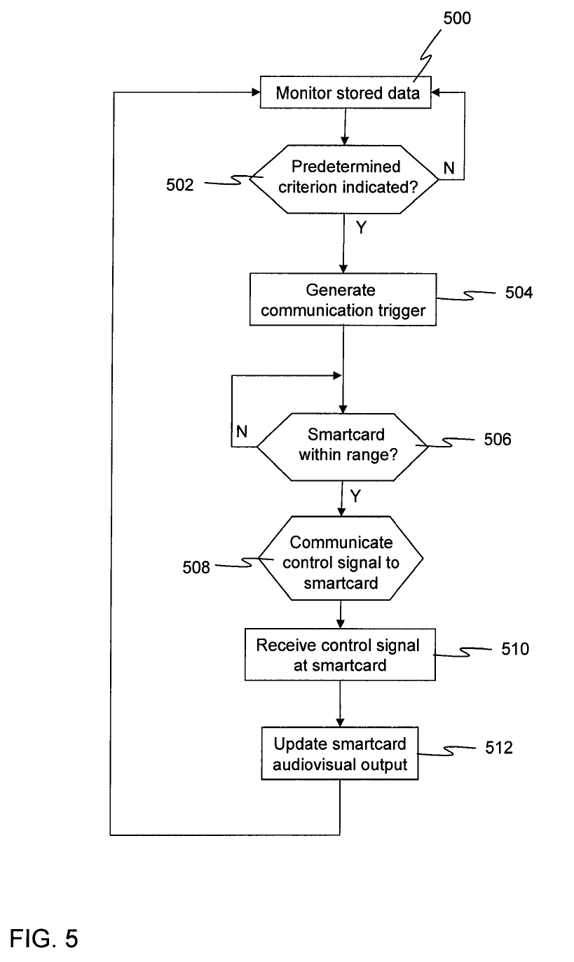

FIG. 5 shows a system flow diagram according to an embodiment of the invention. Computing equipment with access to a database of stored data associated with smartcard audiovisual output monitors the stored data, as shown by step 500. The stored data may be monitoring constantly or at predetermined intervals. If a change in account status and/or a predetermined criterion is indicated, as shown in step 502, a trigger data can be generated in step 504, otherwise monitoring continues in step 500.

In embodiments of the invention, trigger data can serve the purpose of notifying one or more updating terminals that update of audiovisual output of a smartcard is required and that the smartcard should be controlled accordingly. The trigger data may thus be circulated around a number of networked updating terminals.

When a smartcard comes within range of an updating terminal which has been notified, the updating terminal may activate and communicate a control signal to the smartcard, as shown by step 508. The control signal is communicated either wirelessly or via contacts and received at the smartcard in step 510. The smartcard audiovisual output may then be updated, as shown by step 512, under the control of a microchip or microprocessor located in the smartcard. Monitoring of the stored data may then continue in step 500.

In other embodiments of the invention, trigger data, once generated, can be stored centrally, for example in the same database used to store data associated with one or more smartcards. When a smartcard comes within range of an updating terminal, the updating terminal can request that the database is accessed and queried for the existence of any trigger data associated with the smartcard. If such trigger data exists, the trigger data can be transmitted to the relevant updating terminal which may then proceed to control update of the audiovisual output of the smartcard. It should be noted that the trigger data may be for immediate application, or may also contain additional meta-data about the display function and period. For example, by using a system clock signal created within the microprocessor, a message such as ‘Happy Birthday’ may only be displayed for a period of up to 24 hours, on a pre-determined date; or a warning message that the card is due to expire may only be displayed for its last week of validity. Similar messaging and meta-data can be supplied when e.g. credit balance is about to expire or a new service level is about to be achieved (e.g. blue to silver).

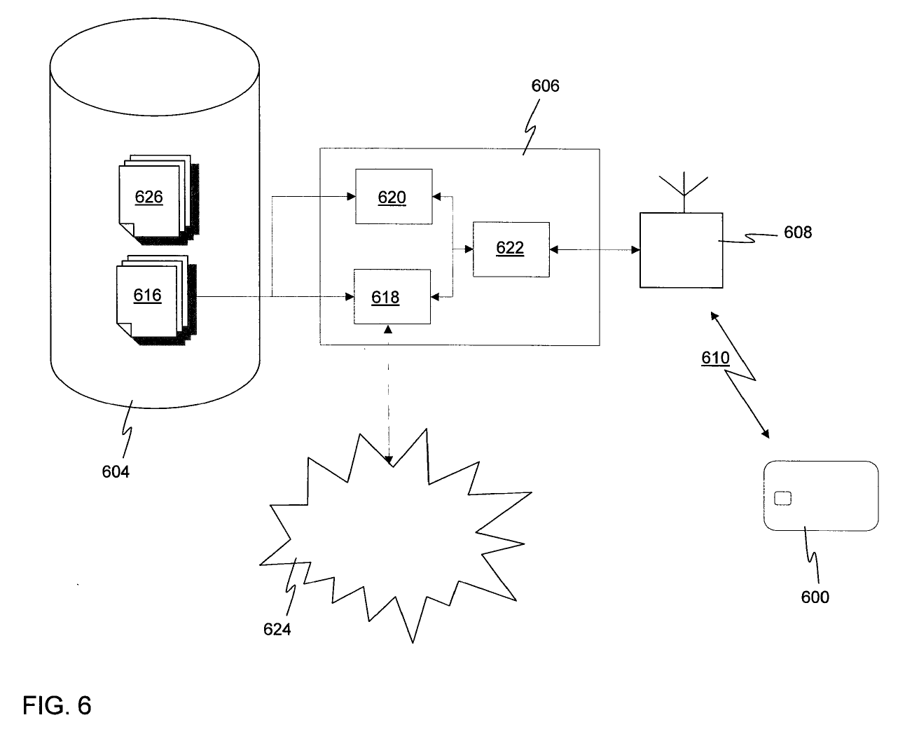

FIG. 6 shows a detailed architecture view according to a still further embodiment of the invention. Similarly to the embodiment of FIG. 3, this embodiment includes a database 604, computing equipment 606, updating terminal 608 and smartcard 600. This embodiment relates particularly to updating of the audiovisual output of a smartcard associated with a bank account, but could equally be applied to a store account or such like. Here, data stored in database 604 includes bank account data 616 and trigger data 626. Bank account data 616 is monitored by a monitoring routine 620 located in computing equipment 606 for indication of a predetermined criterion and/or a change in account status. This could involve for example a certain level of funds being accrued in the bank account.

Bank account data 616 may be updated when funds go into or out of the account. This can be implemented by a transaction processing routine 618 in computing equipment 606 which receives bank account transaction information via network 624, for example when a user of the smartcard withdraws some money from an ATM or a cheque is lodged into their bank account. Network 624 could be any form communications network such as the Internet or a secure finance network. When monitoring routine 620 detects a change in account status and/or a predetermined criterion in bank account data 616, it may inform an event processing routine 622 of such. Event processing routine 622 may then generate trigger data for the smartcard and update trigger data 626 stored in database 604. When smartcard 600 comes within range of updating terminal 608, the terminal can request that database 604 be accessed and queried as to the existence of trigger data for the smartcard. Event processing routine 622 may then access trigger data 626 and if trigger data is present for the smartcard, transmit the trigger data to updating terminal 608.

Updating terminal 608 may then control the audiovisual output of smartcard 600 via communications link 610. This could for example involve updating (in this case upgrading) the audiovisual output of the smartcard from a standard bank account colour such as blue to a more prestigious colour such as gold. Once the audiovisual update has been carried out on the smartcard, trigger data 626 may be updated accordingly.

In an alternative embodiment, when a change in account status and/or predetermined criterion is indicated in the monitored data, event processing routine 622 may send trigger data to a number of updating terminals to notify them that update of the audiovisual output of the smartcard should be carried out if they detect or are informed that the smartcard has come within their communication range. This may occur via one or further event processing routines in the respective updating terminals.

Once the relevant smartcard has come within range of a notified updating terminal, and the updating terminal has controlled the audiovisual update of the smartcard, the updating terminal may inform an event processing routine local to it, which may in turn inform other event processing routines accordingly, including event processing routine 622. In this way, updating terminals may be notified that updating of smartcard 600 has been carried out and there is no longer a need to carry out the audiovisual output update if smartcard 600 comes within range.

Embodiments of the invention are able to control updates of smartcard audiovisual output in conjunction with a credit card balance, or the balance in rewards schemes, such as AirMiles™ or ‘Keep the Change™’, which reward a user's use of the card. In such schemes, each time the smartcard is used, respective points or cash accrue in an associated account. In the Keep the Change™ scheme, for example, when a subscriber to the scheme makes a payment using a credit card associated with the scheme, the transaction amount is rounded up to the nearest unit (for example US Dollar or Pound Sterling). The difference between the original transaction amount and the rounded up FIGURE is then added to the credit card debit amount and transferred to the payee's savings account. Additionally, the difference may be matched, typically subject to an upper threshold limit, and paid into the savings account by the scheme provider.

Hence, in embodiments of the invention, the audiovisual output of a smartcard could be updated to display a current balance of a smartcard user's ‘Keep the Change™’ account or an increase in the balance associated with a recent or current transaction. This update could occur substantially contemporaneously with the purchase transaction, i.e. whilst the smartcard is still inserted at a POS terminal which is being used to authorise the purchase transaction. Alternatively, the ‘Keep the Change™’ account balance could be updated and displayed when the smartcard next comes within range of a different updating terminal. Hence, more than two accounts may be associated with audiovisual output update; for example one account associated with the spending on a credit card account and another account associated with a further account such as a ‘Keep the Change™’ or AirMiles™ account. A smartcard user can thus be kept informed of their balance on one or the other or both of these accounts.

The above embodiments are to be understood as illustrative examples of the invention. Further embodiments of the invention are envisaged.

For example an updating terminal may comprise both wireless and wired communication functionality.

The remotely stored data may be stored at a number of different databases which may be linked together across one or more communication networks.

The additional monitoring routine, transaction processing routine, and event processing routine components in the embodiment of FIG. 6 can equally be employed in the other embodiments described herein. Their function may be implemented centrally at computing equipment responsible for a number of databases, and updating terminals.

Database 604 shown in FIG. 6 may be used to store other data associated with multiple smartcards, bank accounts, store accounts, etc.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of controlling a smartcard, said smartcard being associated with an account and being capable of audiovisual output, said method comprising the steps of:
monitoring data stored remotely from said smart card, said stored data being associated with said audiovisual output;
in response to said monitored data indicating a change in a status of said account, communicating a control signal to said smart card, said control signal being for controlling said smart card to update an audiovisual output thereof.

2. A method according to claim 1, further comprising communicating audiovisual output data to said smartcard with said control signal.

3. A method according to claim 1, wherein said communication to said smart card occurs wirelessly in response to said smart card coming within communication range of an updating terminal.

4. A method according to claim 3, wherein said range comprises a radio frequency range.

5. A method according to claim 3, wherein said range comprises a radio frequency Identification Data (RFID) range.

6. A method according to claim 1, wherein said communication occurs via one or more electrical contacts in response to said smartcard being inserted into an updating terminal.

7. A method according to claim 1, wherein said audiovisual output data relates to visual data to be output from said smartcard.

8. A method according to claim 7, wherein said visual data to be output from said smartcard is capable of changing the appearance of said smartcard.

9. A method according to claim 8, wherein said appearance change affects substantially the whole or a significant part of one or more surfaces of said smartcard.

10. A method according to claim 7, wherein said visual data is capable of being output from said smartcard using electric ink.

11. A method according to claim 1, wherein said audiovisual output data relates to audio data to be output from said smartcard.

12. A method according to claim 1, wherein said stored data comprises data associated with one or more of:
a bank account,
a store account,
a date, and
a time.

13. A method according to claim 12, wherein said audiovisual output is indicative of the status of said bank account and/or said store account.

14. A method according to claim 13, wherein said audiovisual output is indicative of the status of a further account in addition to said bank account and/or said store account, said further account being operable in association with transactions carried out in relation to said bank account and/or said store account.

15. A method according to claim 13, wherein said status comprises a lost or stolen status of said smartcard.

16. A method according to claim 12, wherein said audiovisual output is indicative of the temporal proximity of said date.

17. A method according to claim 1, further comprising the step of updating said stored data.

18. A method according to claim 17, wherein said stored data is updated in response to a change in one or more of a bank account,
a store account,
a date, and
a time.

19. A method according to claim 17, wherein said stored data is updated remotely via a communications network.

20. A method according to claim 1, wherein said account status change comprises a threshold being reached in said stored data.

21. A method according to claim 20, wherein said threshold comprises the amount of money in a user bank account.

22. A method according to claim 20, wherein said threshold comprises the amount of user spending on a user store account.

23. A method according to claim 20, wherein said threshold comprises a date.

24. A system for controlling a smart card, said smartcard being associated with an account and being capable of audiovisual output, said system comprising:
a database adapted to store data remotely from said smart card;
a monitoring means adapted to monitor data stored in said database; and
a communication means adapted to communicate a control signal to said smartcard in response to said monitored data indicating a change in a status of said account, said control signal being for controlling said smartcard to update an audiovisual output thereof.

25. A smartcard adapted for use in a system, said smartcard being associated with an account and being capable of audiovisual output and said system comprising:
a database adapted to store data remotely from said smart card;
a monitoring means adapted to monitor data stored in said database; and
a communication means adapted to communicate a control signal to said smartcard in response to said monitored data indicating a change in a status of said account, said control signal being for controlling said smartcard to update an audiovisual output thereof,
and wherein said smartcard comprises an audiovisual output means adapted to output audiovisual data according to the control signal.

26. A smartcard according to claim 25, wherein said smartcard comprises a receiving means adapted to receive said communicated control signal.

27. A smartcard according claim 25, comprising an audiovisual update means adapted to update said audiovisual output means in response to reception of said communicated control signal.
